(19) United States
(12) Patent Application Publication
(10) Pub. No.: US 2007/0294611 A1
(43) Pub. Date: Dec. 20, 2007

(54) Methods and apparatus for delivering and sharing real estate transaction documents, including title insurance documents

(75) Inventors: Ronald G. McKinney, Lakewood, CO (US); Michael T. Heber, Lone Tree, CO (US); Benjamin L. Kingsolver, Aurora, CO (US)

Correspondence Address: HOLLAND & HART, LLP, P.O BOX 8749, DENVER, CO, 80201, US

(73) Assignee: LT Systems, LLC, Denver, CO (US)

(21) Appl. No.: 11/454,952

(22) Filed: Jun. 15, 2006

(51) Int. Cl. G06F 17/00

(52) U.S. Cl. 715/500

(57) ABSTRACT

In one embodiment, a method of delivering a title insurance document involves 1) electronically reading title insurance information and identifying a number of documents referenced therein; 2) electronically locating the documents in one or more electronic storage locations; and 3) preparing an electronically-deliverable title insurance document having i) title insurance document text, and ii) hyperlinks to the documents. Other embodiments are also disclosed.

### BACKGROUND

Real estate transactions are document intensive transactions that require various documents to be prepared and/or located. Typically, the documents involved in a real estate transaction are prepared or located by a title company.

One of the more labor intensive documents that needs to be prepared during a real estate transaction is the title insurance commitment. A title insurance commitment not only requires language that complies with federal, state and local laws, but also requires citations to various documents pertaining to, for example: chain of title for a property, requirements that must be met before a title policy can be issued for a property, and encumbrances on a property. Before these documents can be cited in the title insurance commitment, these documents need to be located (either manually or electronically).

Once the documents involved in a real estate transaction are prepared and/or located, they are delivered to the various parties that are involved in the transaction (e.g., the lender, the real estate agent(s), the buyer(s), and the seller(s)). If the documents are revised, revised copies of the documents may also need to be delivered to the parties.

Given the document intensive nature of real estate transactions, new methods and apparatus that aid in any or all of the following are desirable: 1) improving the speed at which documents can be prepared and/or located, 2) improving the management of real estate documents and their revisions, and 3) reducing the amount of paper that needs to be delivered to a transaction's parties.

### BRIEF DESCRIPTION OF THE DRAWINGS

Illustrative embodiments of the invention are illustrated in the drawings, in which:

FIG. 1 illustrates an abbreviated form of an exemplary title insurance commitment;

FIG. 2 illustrates a first exemplary method for delivering a title insurance document, such as a title commitment;

FIG. 3 illustrates an exemplary title commitment, prepared in accord with the method shown in FIG. 2;

FIG. 4 illustrates a second exemplary method for delivering a title insurance document;

FIG. 5 illustrates an exemplary method for sharing real estate transaction documents;

FIG. 6 illustrates an exemplary web-based interface via which the method shown in FIG. 5 may be implemented; and

FIG. 7 illustrates a means for specifying additional parties to a real estate transaction (via the interface shown in FIG. 6).

### DETAILED DESCRIPTION

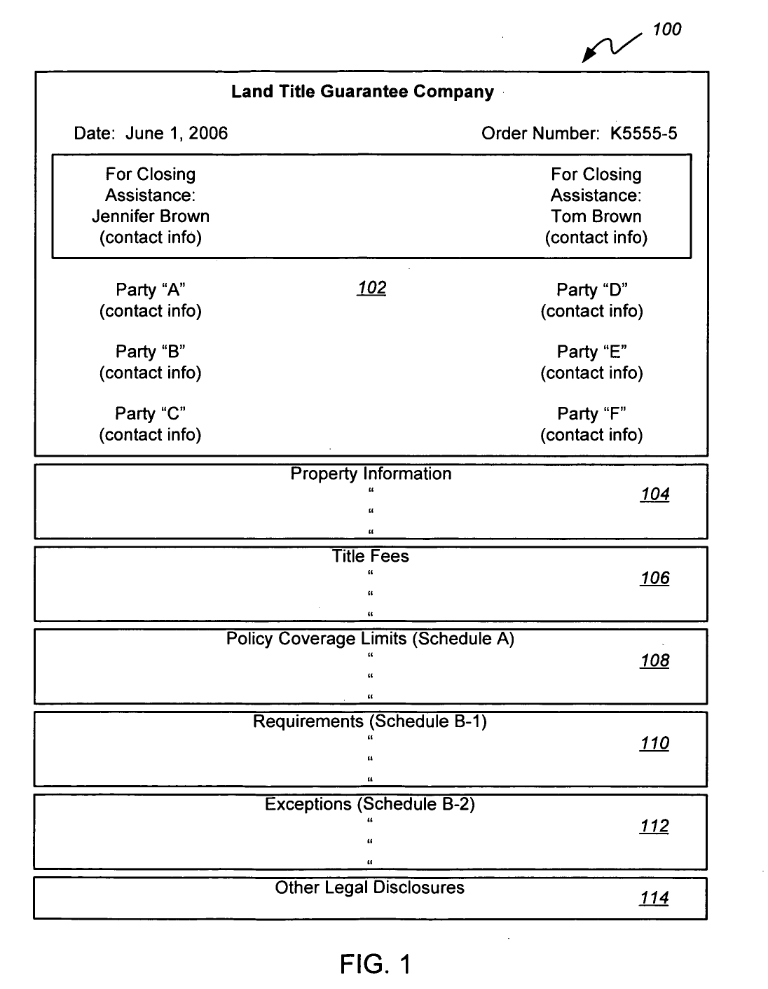

One of the more labor intensive documents that needs to be prepared during a real estate transaction is the title insurance commitment. An abbreviated form of an exemplary title insurance commitment 100 (or title commitment, as it is commonly referred to) is shown in FIG. 1.

The title commitment 100 shown in FIG. 1 comprises various sections, but generally includes 1) an identification 102 of the parties to a real estate transaction, 2) an identification 104 of the property for which a title insurance commitment is being made, 3) an indication of the costs 106 and coverage limits 108 of the title insurance policies that a title company is willing to issue for the property, including what is commonly referred to as “Schedule A”, 4) a list of requirements 110 that must be complied with before title insurance policies will be issued (commonly referred to as “Schedule B-1”), 5) a list of exceptions 112 that will flow with any title insurance policies that are issued (commonly referred to as “Schedule B-2”), and 6) various other legal disclosures 114. Of note, various documents pertaining to chain of title, tax certificates, plat maps, and other recorded and non-recorded documents may be cited in a title commitment.

Historically, the generation of a title commitment required a title examiner to manually search volumes of recorded documents, stored in paper form, in a city or county Clerk's or Recorder's office. However, in recent years, many recorded and non-recorded documents have been digitized, and a title examiner's search can now be conducted electronically.

Many of the documents that a tile examiner needs to locate are stored in local or regional “title plants”. A title plant is merely a data center or other electronic storage service that provides access to an indexed collection of documents. At times, a title company will host its own title plant, which may store 1) documents that are peculiar to particular transactions, and that are not generally available to the public or other title companies, and 2) cached copies of documents that have been retrieved from other title plants.

When generating a title commitment, a title examiner needs to assemble various paragraphs of text, some of which are dictated by federal, state and local laws or regulations, and some of which are determined by the property, parties and documents that are involved in a particular real estate transaction. The title examiner also needs to insert citations to the various documents that are referenced by, or that support, the paragraphs of text. One way to do this is by typing a title commitment from start to finish, or otherwise cutting, pasting and inserting text to generate a text-based title commitment. Another way to generate a title commitment is to enter paragraph text, property and party information, policy cost and coverage details, and document references, into a database of information from which a formal title commitment can be generated. In some cases, such systems may be partly automated, with formatting rules and boilerplate language being derived from one or more templates or jurisdictional rule sets.

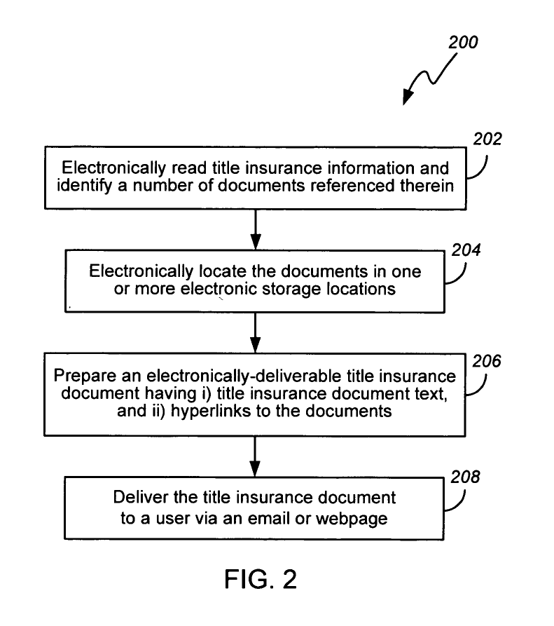

Once a title commitment is prepared, it is typically delivered in one of three ways: via paper (i.e., a mail or fax copy); via an electronic text file (such as a PCL or XML file); or via an electronic image file (such as an Adobe Acrobat file). Often, the title commitment is delivered with a set of all of the documents that are referenced in the title commitment. The documents may be delivered in paper form, or by means of electronic image files. Delivering copies of the documents via paper is costly and wasteful, while delivering copies of the documents electronically can be resource intensive (and thus costly) and/or prohibitive (e.g., if the size of the document set is too large for a user to receive via email or as a web download). To alleviate these problems, FIG. 2 illustrates a first exemplary method 200 for delivering a title insurance document, such as a title commitment. The method 200 comprises electronically reading title insurance information to identify a number of documents referenced therein (see block 202). The documents are then located electronically, in one or more electronic storage locations (see block 204). Thereafter, title insurance document text, and hyperlinks to the located documents, are assembled to prepare an electronically-deliverable title insurance document (see block 206). In one embodiment, the electronically-deliverable document is an HTML document.

Ultimately, the title insurance document may be delivered to a user via, for example, an email or webpage (see block 208). Paper copies of the document may also be generated from the electronically-deliverable document, although the advantages provided by the hyperlinks will be lost.

The method 200 is useful, in one respect, in that it enables a title insurance document to be delivered without copies of the documents that it references. It is also useful in that it enables referenced documents to be easily retrieved for viewing or printing. The method 200 is also useful in that it 1) enables hyperlinks to be created from title insurance information that does not initially contain hyperlinks, and 2) enables creation of the hyperlinks without user intervention.

In one embodiment of the method 200, title insurance information is read by parsing a plurality of database fields. As the fields are parsed, documents referenced therein may be identified in various ways. For example, documents may be identified by means of document number, or by year, county, reception number or book/page.

To handle variations in the way title insurance information is entered in a database field, different names or abbreviations for the same thing may be mapped to a common document identifier. For example, different date formats might be mapped to a common date format, or the names “Denver County”, “Denver Co.”, “Den. County” and “County of Denver” might be mapped to the common document identifier of “Denver County”.

In some cases, a single database field may be parsed for references to multiple documents. In these cases, a windowing technique may be used to identify related pieces of information that, together, identify a single document.

After extracting one or more document identifiers from a set of title insurance information, the document identifiers may be used to locate the documents in one or more electronic storage locations, such as one or more title plants. In one embodiment, a prioritized set of title plants is searched for the documents. For example, searching may begin in a proprietary or local title plant maintained by a title company that is executing the method 200. If a local copy of a document cannot be located, a search for the document may then proceed to one or more external title plants. In some cases, the manner or order in which title plants or other electronic storage locations are searched is dependent on the county or other jurisdiction for which documents are being located.

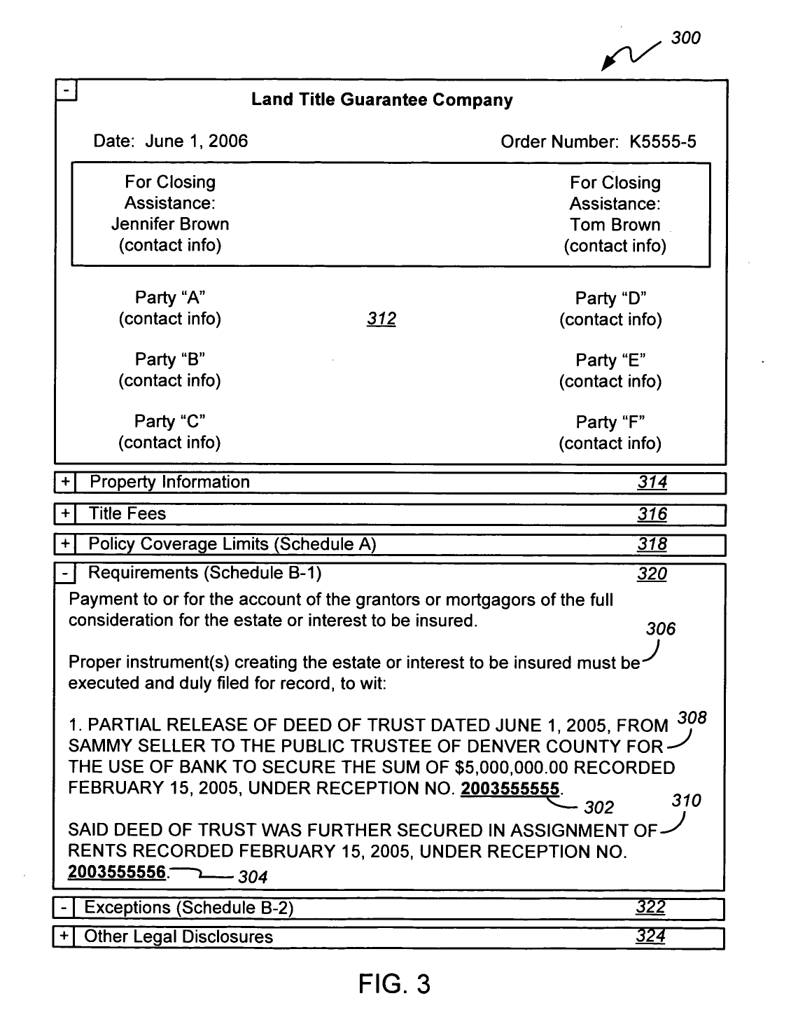

The title insurance document prepared by the method 200 may take various forms, including those of a title commitment or title policy. An exemplary title commitment 300, prepared in accord with the method 200, is shown in FIG. 3. As shown, the commitment's hyperlinks 302, 304 to other documents may be embedded or intermixed with the various textual clauses 306, 308, 310 of the commitment 300. In some cases, the hyperlinks 302, 304 may follow other identifiers of the documents, while in other cases, the hyperlinks may take the place of other identifiers of the documents (as shown in FIG. 3). In the title commitment 300, the hyperlinks 302, 304 take the form of alphanumeric text. However, the hyperlinks 302, 304 could alternately take the form of graphic icons.

In one embodiment, an electronically-deliverable title insurance document is prepared by grouping at least some of the title insurance document's text and hyperlinks in different sections of the title insurance document. For example, in the case of a title commitment, different sections 312, 314, 316, 318, 320, 322, 324 may be provided for identifying 1) the parties to a real estate transaction, 2) the property for which a title insurance commitment is being made, 3) the coverage limits of the title insurance policies that a title company is willing to issue for the property, 4) the requirements that must be complied with before title insurance policies will be issued, and 5) the exceptions that will flow with any title insurance policies that are issued. The sections 312-324 may then be flagged, formatted or programmed to enable a viewer of the title insurance document, such as a web browser, to expand or collapse ones of the sections (e.g., by clicking the “+” or “−” boxes at the top of each of the sections 312-324).

In the event that a title insurance document is linked to an incorrect document, a text editor, fillable field, or search field may provide a means for correcting a hyperlink. Such a mechanism may be provided for use by a party to whom an electronically-deliverable title insurance document is delivered, or by a party (e.g., a title examiner) that reviews the title insurance document prior to its delivery to another party.

The method 200 may be implemented by means of computer-readable program code stored on computer-readable storage media. The computer-readable storage media may include, for example, any number or mixture of fixed or removable media (such as one or more fixed disks, random access memories (RAMs), read-only memories (ROMs), or compact discs), at either a single location or distributed over a network. The computer-readable program code will typically comprise software, but could also comprise firmware or a programmed circuit.

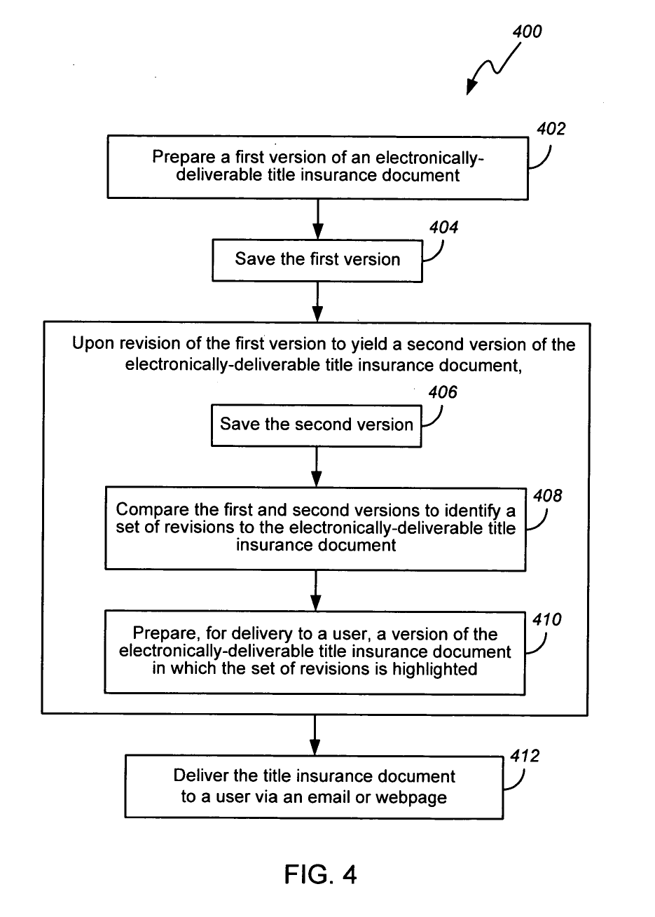

FIG. 4 illustrates a second exemplary method 400 for delivering a title insurance document. The method 400 may be used with or without the method 200. The method 400 comprises preparing and saving a first version of an electronically-deliverable title insurance document (see blocks 402 and 404). Upon revision of the first version to yield a second version of the electronically-deliverable title insurance document, the second version is also saved (see block 406), and the first version is compared to the second version to identify a set of revisions to the electronically-deliverable title insurance document (see block 408). A version of the electronically-deliverable title insurance document in which the set of revisions is highlighted is then prepared for delivery to a user (see block 410). In some cases, the highlighted title insurance document may be delivered to a user via an email or a webpage (see block 412).

The manner in which revisions to a title insurance document are highlighted may take various forms, including: displaying revised text in a different color, in a different font, in bold-faced type, in italics, underlined, or with a different background color.

In some cases, the set of highlighted revisions may contain only certain types of revisions. For example, additions may be highlighted, but deletions may not be.

As with the method 200, the method 400 may be implemented by means of computer-readable program code stored on computer-readable storage media.

Although the methods 200 and 400 have been disclosed to apply to the delivery of “title insurance documents”, the methods 200 and 400 can also be applied to other types of real estate transaction documents, such as “ownership and encumbrance” documents (i.e., O&E documents).

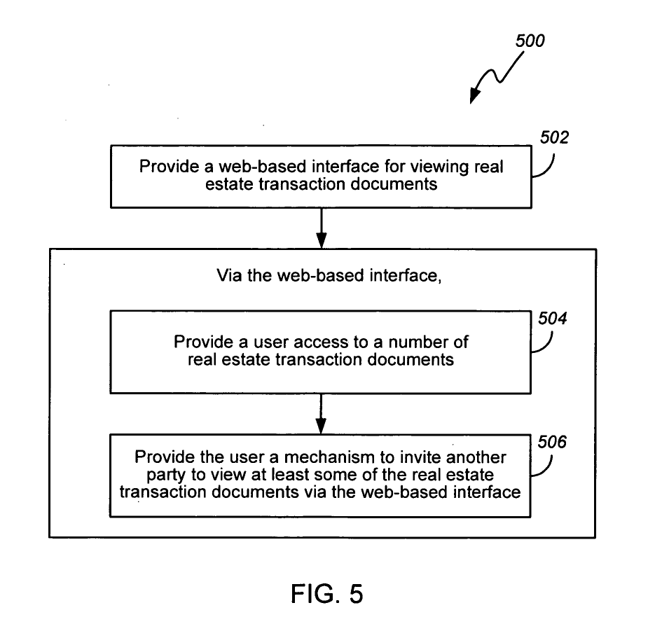

Turning now to FIG. 5, there is shown an exemplary method 500 for sharing real estate transaction documents. The method 500 comprises providing a web-based interface for viewing real estate transaction documents (see block 502). Via the web-based interface, a user is provided 1) access to a number of real estate transaction documents (see block 504), and 2) a mechanism to invite another party to view at least some of the real estate transaction documents via the web-based interface (see block 506).

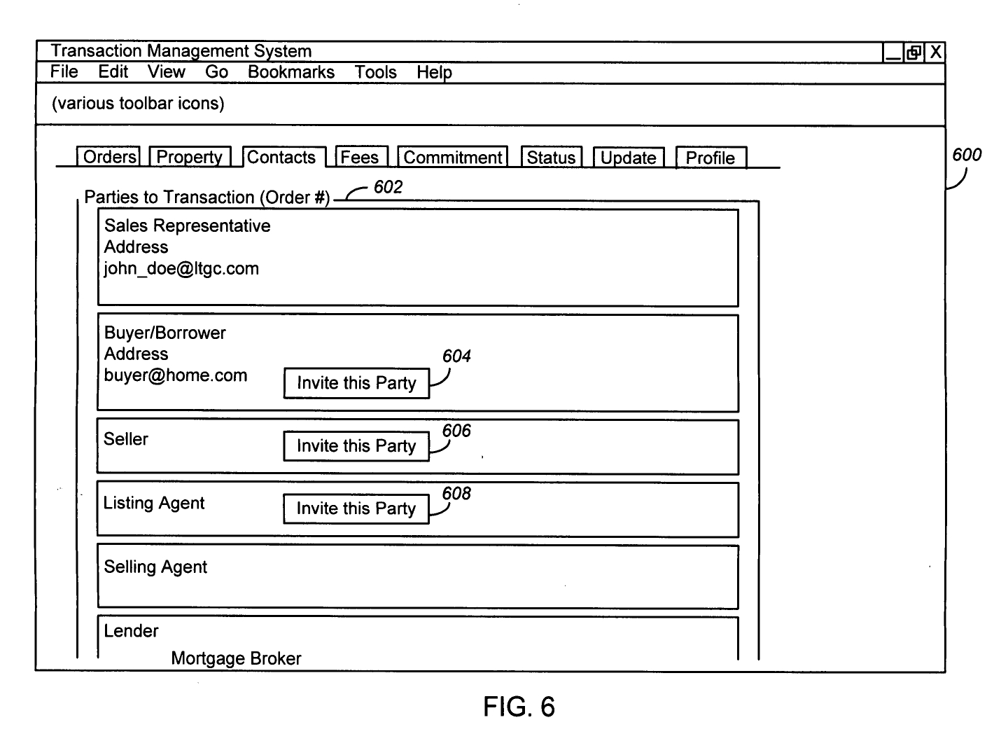

FIG. 6 illustrates an exemplary web-based interface 600 via which the method 500 may be implemented. The interface 600 provides a list 602 of parties to a real estate transaction. Associated with each party that has not already been invited to participate in the real estate transaction is a graphically clickable button 604, 606, 608. In one embodiment, each of these buttons 604, 606, 608 is labeled “Invite this Party”. By clicking one of the buttons 604, 606, 608 (e.g., with a mouse), the associated party may be invited to a real estate transaction by, for example, the automatic sending of an email to the party. For convenience, a party's email or other contact information can be displayed via the interface 600. If a party's email has not been provided, the user may be prompted to provide the party's email and/or a temporary password.

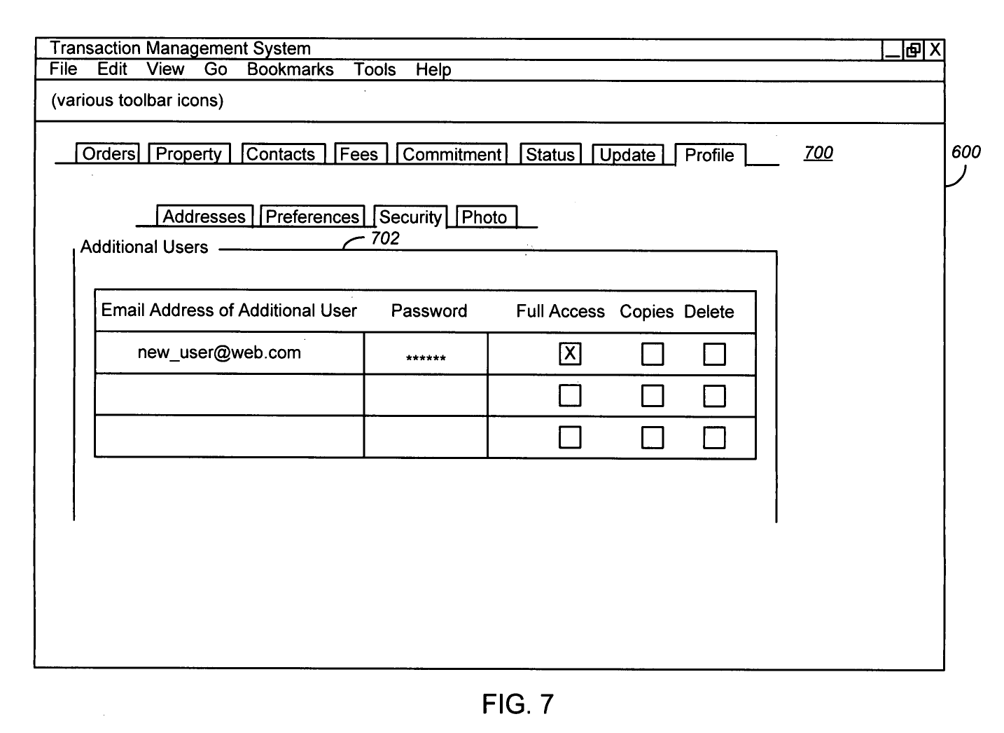

In one embodiment, the interface 600 may comprise a means (e.g., a webpage 700) for specifying additional parties to a real estate transaction. See FIG. 7. The interface 600 may also provide a tool 702 for specifying different access rights for the different parties that a user may invite to a real estate transaction. The access rights may specify which documents, or sets of documents, can be accessed by the different parties. The access rights may also specify “how” a document may be accessed by a party. For example, the access rights may specify whether an invited party has the authority to copy, modify or delete a document.

Parties that are invited to a real estate transaction may be given the authority to invite additional parties. For example, invited parties may be given access to the interface 600 (and “Invite this Party” buttons) shown in FIG. 6. In one embodiment, a user's click on one of the “Invite this Party” buttons triggers software to determine whether the access rights of a user or invited party authorize the user or invited party to invite a particular party. For example, in one embodiment, a title company employee may be allowed to invite any party; a real estate agent or attorney may only be allowed to invite the party or parties that they represent; and a builder (or lender) may be only be allowed to invite the buyer (or borrower).

Preferably, the documents that a party is invited to view via the method 600 are grouped by transaction. In this manner, a user may be caused to select a particular real estate transaction before viewing the interface 600; and an invited party is thereby invited to view documents pertaining to only a single real estate transaction.

As with the methods 200 and 400, the method 500 may be implemented by means of computer-readable program code stored on computer-readable storage media.

What is claimed is:

1. A method of delivering a title insurance document, comprising:
electronically reading title insurance information and identifying a number of documents referenced therein;
electronically locating the documents in one or more electronic storage locations; and
preparing an electronically-deliverable title insurance document having i) title insurance document text, and ii) hyperlinks to the documents.

2. The method of claim 1, wherein electronically reading the title insurance information comprises parsing a plurality of database fields.

3. The method of claim 1, wherein electronically reading the title insurance information comprises parsing a single database field for references to multiple documents.

4. The method of claim 1, wherein the title insurance document is a title commitment.

5. The method of claim 1, wherein the title insurance document is a title policy.

6. The method of claim 1, wherein the one or more electronic storage locations comprise a prioritized set of title plants.

7. The method of claim 1, further comprising, delivering the title insurance document to a user via an email.

8. The method of claim 1, further comprising, delivering the title insurance document to a user via a webpage.

9. The method of claim 1, further comprising, delivering the title insurance document to a user, without copies of the documents that are referenced by the hyperlinks.

10. The method of claim 1, wherein preparing the electronically-deliverable title insurance document comprises:
grouping at least some of the title insurance document text and hyperlinks in different sections of the title insurance document; and
enabling a viewer of the title insurance document to expand or collapse ones of the sections.

11. Apparatus, comprising:
computer-readable storage media; and
computer-readable program code, including,
code to electronically read title insurance information and identify a number of documents referenced therein;
code to electronically locate the documents in one or more electronic storage locations; and
code to prepare an electronically-deliverable title insurance document having i) title insurance document text, and ii) hyperlinks to the documents.

12. A method of delivering an ownership and encumbrance document, comprising:
electronically reading ownership and encumbrance information and identifying a number of documents referenced therein;
electronically locating the documents in one or more electronic storage locations; and
preparing an electronically-deliverable ownership and encumbrance document having i) ownership and encumbrance document text, and ii) hyperlinks to the documents.

13. A method of delivering a title insurance document, comprising:
preparing a first version of an electronically-deliverable title insurance document;
saving the first version; and
upon revision of the first version to yield a second version of the electronically-deliverable title insurance document, i) saving the second version, ii) comparing the first and second versions to identify a set of revisions to the electronically-deliverable title insurance document, and iii) preparing, for delivery to a user, a version of the electronically-deliverable title insurance document in which the set of revisions is highlighted.

14. The method of claim 13, wherein at least one of the set of revisions is highlighted by displaying it in a different color.

15. The method of claim 13, wherein the identified set of revisions contains only certain types of revisions.

16. The method of claim 13, wherein the title insurance document is a title commitment.

17. The method of claim 13, wherein the title insurance document is a title policy.

18. The method of claim 13, further comprising, delivering the title insurance document in which the set of revisions is highlighted to a user, via an email.

19. The method of claim 13, further comprising, delivering the title insurance document in which the set of revisions is highlighted to a user, via a webpage.

20. Apparatus, comprising:
computer-readable storage media; and
computer-readable program code, including,
code to prepare a first version of an electronically-deliverable title insurance document; and
code to, upon revision of the first version to yield a second version of the electronically-deliverable title insurance document, i) compare the first and second versions to identify a set of revisions to the electronically-deliverable title insurance document, and ii) prepare, for delivery to a user, a version of the electronically-deliverable title insurance document in which the set of revisions is highlighted.

21. A method of sharing real estate transaction documents, comprising:
providing a web-based interface for viewing real estate transaction documents; and
via the web-based interface,
providing a user access to a number of real estate transaction documents; and
providing the user a mechanism to invite another party to view at least some of the real estate transaction documents via the web-based interface.

22. The method of claim 21, wherein the real estate transaction documents are grouped by real estate transaction, and wherein the mechanism to invite another party requires specification of a real estate transaction to which the another party is invited.

23. The method of claim 21, further comprising, via the web-based interface, providing the user a tool for specifying different access rights for different parties that the user may invite via the mechanism to invite another party, the different access rights specifying which of the real estate transaction documents can be accessed by the different parties.

24. The method of claim 23, wherein the different access rights further specify how the real estate transaction documents can be accessed by the different parties.

25. The method of claim 21, wherein the mechanism to invite another party is a graphically clickable button that is associated with the another party.

26. The method of claim 21, further comprising, via the web-based interface,
providing the user a list of parties that are known to be associated with a particular real estate transaction; and
providing a mechanism to invite selected ones of the parties to view at least some of the real estate transaction documents via the web-based interface.

27. The method of claim 26, wherein the mechanism to invite selected ones of the parties comprises a number of graphically clickable buttons, each of which is associated with a particular one of the parties.

28. The method of claim 21, further comprising:
via the web-based interface, providing to the another party the mechanism to invite another party; and
upon the user or the another party using the mechanism to invite another party, determining, based on access rights of the user or the another party, whether the user or the another party is authorized to invite a particular party.

29. Apparatus, comprising:
computer-readable storage media; and
computer-readable program code, including,
code to provide a web-based interface for viewing real estate transaction documents; and
code to, via the web-based interface,
provide a user access to a number of real estate transaction documents; and
provide the user a mechanism to invite another party to view at least some of the real estate transaction documents via the web-based interface.
